(19) United States
(12) Patent Application Publication
(10) Pub. No.: US 2008/0024267 A1
(43) Pub. Date: Jan. 31, 2008

(54) Forced arming

(75) Inventors: Mark Jones, Long Beach, CA (US); Sam Talpalatsky, San Diego, CA (US)

Correspondence Address: SAM TALPALATSKY, 10867 CLOVERHURST WAY, SAN DIEGO, CA, 92130, US

(73) Assignee: MAGNADYNE CORPORATION, COMPTON, CA (US)

(21) Appl. No.: 11/247,567

(22) Filed: Oct. 10, 2005

Related U.S. Application Data
(63) Continuation-in-part of application No. 11/070,520, filed on Mar. 2, 2005.
(60) Provisional application No. 60/715,798, filed on Sep. 9, 2005.

(51) Int. Cl. H04Q 1/00

(52) U.S. Cl. 340/5.1

(57) ABSTRACT

A vehicle security system comprising a controller and a plurality of authorized transmitters. The authorized transmitters configured to operate in a passive arm mode, wherein the transmitters transmit a periodic passive disarm signal to the controller. The disclosed embodiments teach a controller that arms in the presence of passive disarm signals and disarms upon receipt of an active disarm signal or upon detecting that a passive transmitter left the vicinity of the vehicle and subsequently returned.

### CROSS-REFERENCE TO RELATED APPLICATION

This application is a continuation-in part of co-pending United States utility application entitled, “Passive Transmitter,” having Ser. No. 11/070520, filed Mar. 2, 2005, which is entirely incorporated herein by reference.

This application claims priority to copending United States provisional application entitled, “Forced Arming,” having Ser. No. 60/715798, filed Sep. 9, 2005, which is entirely incorporated herein by reference.

### BACKGROUND

1. Field of the Invention

The present application relates generally to vehicle security and convenience systems, employing a transmitter that automatically or passively activates some or all of the functions controllable by a vehicle mounted controller programmed to respond to such transmitters.

2. Discussion of the Prior Art

Vehicle security and convenience systems have evolved over time. One of the more significant contributions of these systems is the remote access to the vehicle and the ability to disable one or more of the normal vehicle operating functions, such as the ability to start the vehicle. By sending an arm signal from an authorized transmitter, the prior art systems are designed to lock the doors and prevent the vehicles from starting or operating. To achieve this functionality, the prior art security systems included a controller installed in a vehicle that is responsive to a remote control transmitter. The controller controls the operation of various functions such as lights, door locks, and security features such as the starter disable and ignition cutoff.

One of the drawbacks to the prior art systems is the requirement of actively controlling the controller by pressing switches on the transmitter, i.e. the active mode. As an example, active mode is undesirable when the user's hands are full. To address this need the industry introduced passive transmitters that passively, i.e. automatically and periodically transmit unlock or disarm signal.

Although passive transmitters are effective, they also have drawbacks under certain conditions. One of such drawbacks is the inability to leave the vehicle armed with a passive transmitter in the vicinity of the controller and its receiver. In this scenario, the passive transmitter will continue to disarm the system and the user will not be able to lock and/or arm the system and therefore secure the vehicle.

### SUMMARY

The disclosed device and method are typically employed by a controller/receiver of a vehicle system that manages the security and/or convenience features of a vehicle (hereafter referred to as the “controller”). A typical vehicle employs a controller that receives either arm or disarm signals from a remote transmitter. Where passive transmitters are employed, such transmitters periodically transmit such disarm signals. Therefore, as the authorized passive transmitter approaches the vehicle, it automatically or passively transmits a disarm signal, which is in turn received and recognized by the controller. As the passive transmitter goes out of physical transmission range, the controller automatically arms and typically locks and/or secures the vehicle in accordance with its internal routines.

The disclosed device and method resolve a number of needs, including the one arising from a scenario where the controller is within reception range of multiple passive transmitters. For example, such situations arise when a second authorized transmitter is left in the vehicle and the user walks away with his/her primary transmitter (usually attached to a set of keys). Another situation arises when a vehicle is parked in the vicinity of such second transmitter in and about a residence. In these situations, the second, authorized transmitter continues to send its passive disarm command and keep the vehicle from entering its armed state.

The disclosed embodiments and methods allow the user to “force-arm” the passive system. In one embodiment the forced arming is achieved automatically when one or more of the authorized, passive transmitters leaves the signal reception range of the controller. The controller will then disregard the disarm signals from the remainder of the authorized transmitters that are within its reception range. In this embodiment, the controller will maintain its armed state and disarm when a new authorized transmitter is in range, or one of the transmitters returns in range.

In another embodiment, the user or another routine places the controller in a forced-arm mode where the controller arms and disregards the passive disarm signals of authorized transmitters in its range. This is achieved through a user initiated signal, such as turning the ignition on and off a number of times within some number of seconds. The user initiated signal could also comprise any number of, combination of or timing of user controllable signals sensible by the controller, such as sensor inputs. The controller will then disarm upon receiving an active disarm signal from an authorized transmitter.

Yet in another embodiment, the user or another routine places the controller in a forced-arm mode where the controller arms and disregards the passive disarm signals of authorized transmitters in its range. The controller will then disarm upon receiving an active disarm signal from an authorized transmitter as described in the latter embodiment, or the controller will enter into its normal passive disarm mode when the controller stops receiving the passive disarm commands from all of the authorized transmitters. In a normal, passive mode the controller will disarm upon receipt of a passive disarm signal from one of the passive transmitters that returns to controller's reception range. Yet in another variation of this embodiment, the user or the manufacturer could define this forced-arm routine to only disarm with an active disarm command from one of the authorized transmitters. Although this could be set as a nominal way to arm and disarm the controller, the number of times the controller is armed and disarmed subsequent to the user initiated signal to the controller that places the controller in this forced-arm mode, is definable from once to n-number of times.

Other systems, methods, features, and advantages of the disclosed systems and methods will be or become apparent to one of skill in the art upon examination of the following drawings and detailed description. It is intended that all such additional systems, methods, features, and advantages be included within this description and be within the scope of the disclosure.

### BRIEF DESCRIPTION OF THE DRAWINGS

FIG. 1 illustrates a representative block diagram of one or more authorized transmitters and the controller.

FIG. 2 illustrates a flow chart of one embodiment of the controller comprising the described passive forced-arm capability and where the controller is passively disarmed by the returning passive transmitter or another authorized transmitter.

FIG. 3 illustrates a flow chart of another embodiment of the controller comprising the described passive forced-arm capability and where the controller is actively disarmed by the returning passive transmitter.

FIG. 4 illustrates a flow chart of a variant embodiment of the controller comprising the described passive forced-arm capability and where the controller is actively disarmed by the returning passive transmitter.

FIG. 5 illustrates a flow chart of a variant embodiment of the controller comprising the described passive forced-arm capability and where the controller is actively disarmed by the returning passive transmitter, or in the alternative, in the absence of any passive signals, the controller returns to its nominal routine.

### DETAILED DESCRIPTION

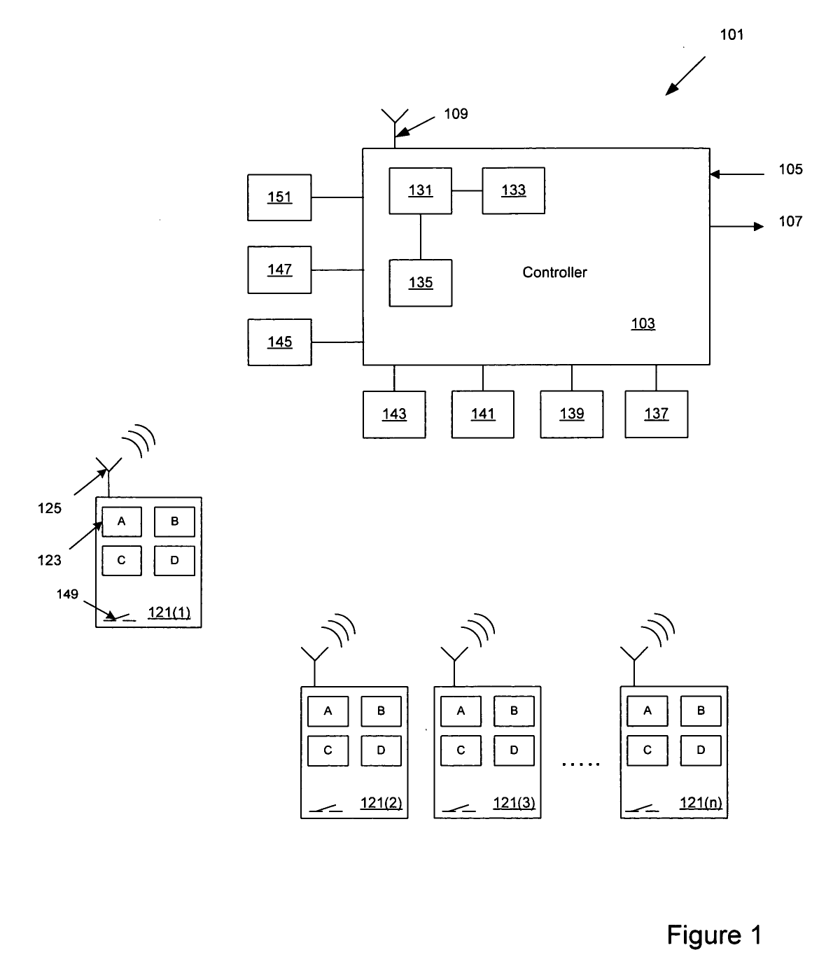

Shown in FIG. 1, is a representative security and/or vehicle convenience system (hereafter the collectively “system”) 101. System 101 generally comprises one or more authorized transmitters 121 capable of transmitting command signals to a controller 103. In response controller 103 executes commands received from such authorized transmitters 121 or commands programmed into its structure. The structure of controller 103 consists, but is not limited to a memory 133; a logic execution device 131, such as a microprocessor; a receiver (not illustrated); a decoder 135; one or more on-board and/or off-board relays 139; an on-board and/or off-board visual indicator 141, such as a light emitting diode; an antenna 109; an override switch 143, commonly referred to as a valet switch; and an acoustical transducer 137 such as a siren. It is foreseeable that some or all of these components may be integrated into one or more integrated units, by consolidating discrete circuitry into one or more ICs (integrated circuits).

The command signal(s) generally comprises an authorization identification code particular to transmitter 121 that sent it (the “ID”). This authorization ID code is initially programmed into controller 103. Thus signals with the authorized ID code will have access to and control of controller 103 via one or more authorized transmitters 121. Also part of the command signal is a command code. The command code communicates to controller 103 the function that the authorized user wants executed. Examples of such functions, among others, are electrical signals via relays 139, control lines 107 or bus 107 to lock doors, unlock doors, flash lights, open the trunk, lower or raise windows, and sound siren 137. These commands are initiated by a user activating one or more switches 123 of authorized transmitter 121. Typically, the command signal is transmitted via transmitters internal structure including its antenna 125 and it is received by an antenna 109 coupled to a receiver (not illustrated) of controller 103, decoded by a decoder 135 and the resulting digital string of the signal is then passed on to processor or logic and/or software 131 (hereafter collectively “logic circuitry 131 ”). Logic circuitry 131 then checks if the authorization code of the received command signal matches a previously programmed authorization code normally resident in a memory 133. If the received and stored authorized codes match, then controller 103 executes the command code of the received signal.

Outputs 107 control various functions in response to commands received from transmitter 121 or in response to conditions programmed into controller 103. Some of the exemplary functions are: 1) signal to lock and unlock the doors of a vehicle, either in response to transmitter 121 or automatically (corresponding to passive arming) after a period of time; 2) flashing of lights, such as parking lights to provide a visual indication of executing a function (also commonly performed through relays 139); 3) audio feedback, such as the beeping of horn via one or more relays 139 or some other audio transducer 137, thereby providing an audio indication of executing a function; 4) starting of the vehicle; 5) controlling the trunk of the vehicle; 6) raising or lowering windows of the vehicle; 5) operational interrupt or cutoff via one or more relays 139, disabling a starting circuit or ignition circuit of the vehicle; and/or 6) any other function of the vehicle.

Input(s) 105 provides controller 103 with control signals or conditional indication of one or more sensors 147 are placed about the vehicle. One example is a shock sensor, indicating a shock or a physical disturbance in or about the vehicle. Shock sensor and other sensors 147 could have either a dedicated input as diagrammatically shown in FIG. 1, a harness input 105 or they can be electrically coupled to a data bus (illustrated as input 105), providing digital or analog indication that the sensor was triggered. Another example of sensor 147 is one or more pin switches 151, indicating that one or more of the doors are open, including the hood and/or trunk. Yet another example is a signal from an infrared signal or magnetic field sensor 147. Visual indicator 141 is common place in security systems, providing a visual indication of the controller's status. As one example, the indicator 141 could be a light emitting diode, flashing to indicate that the system is armed. Such indicators 141 are commonly placed in a conspicuous place on or about the dash of the vehicle to warn away the potential intruders.

Also a part of a typical system 101 is override switch 143, commonly referred to as a “valet” switch. Switch 143 is inconspicuously mounted by the installer in the vehicle and its location is provided to the authorized user. Switch 143 has a number of functions, one of which is to disarm controller 103. In other applications it is used to program controller 103. Yet in other applications it can be employed to instruct or signal controller 103.

Although inputs such as, but not limited to, input 105, relay 139, visual indicator 141, override switch 143, sensor(s) 147, and pin switch(es) 151 are illustrated having dedicated input to controller 103, these inputs and other units coupled to controller 103 could be coupled through a bus now employed in a number of vehicles and collectively indicated in FIG. 1 as input(s) 105. This bus has a predetermined protocol and it allows the vehicle manufacturer to apply a number of electrical units without having to install dedicated harnesses or wiring to control them. This is a cost, power and weight savings, as well as a way to reduce a number of parts, thus increasing the reliability.

Having described a typical security and vehicle convenience system 101, attention is drawn to a passive arming functionality. By way of review, passive arming refers to controller 103 that automatically arms or performs a set of functions within a specified time after ignition is turned off. Yet in other systems, such automatic arming occurs after the ignition is turned off and a pin switch 147 changes from a first state to a second state and back to the first state, indicating that the user turned off the vehicle, opened the door and closed it.

Also controller 103 could be passively disarmed. In a system with passive disarm functionality a passive transmitter sends an unlock signal to controller 103 without the user having to press one or more switches 123 of transmitter 121. Some passive transmitters 121 passively (periodically and automatically) send such signals every n-seconds (the period defined by the user or the manufacturer). Therefore, as the user approaches the vehicle and controller 103, once in range, controller 103 receives the passively generated and transmitted disarm signal and the vehicle is unlocked by the time the user reaches the vehicle. Yet other systems recognized that such passive transmitters use more battery power than active transmitters that only send the signal when activated via switches 123. To resolve the power drain concerns, such transmitters gate its passive transmission with motion detection, either electronic or mechanical. Thus, the periodic signal is sent when the on-board sensor detects some movement of the transmitter.

Disclosed in a commonly owned, copending U.S. patent application entitled “PASSIVE TRANSMITTER,” Ser. No. 11/070520, is a transmitter 121 that automatically turns off the passive arming functionality when its power source, such as a battery, reaches some defined capacity threshold. Thus, regardless of whether the transmitter is gated with a motion sensor or is continuously in passive mode, once the battery or its power reserves reach some predetermined level, the passive functionality will revert to active functionality. When the user senses that the system 101 no longer unlocks the doors and/or disarms controller 103 automatically/passively, it is an indication that the battery in transmitter 121 should be changed. Moreover, the user still has full control of system 101.

Also disclosed is transmitter 121 that can be changed by user from the passive mode to the active mode and vice versa. This allows the user, in addition to the power level protection described above, to change the modes at will. Some users will simply prefer the active mode over the passive mode. Others will place transmitter 121 in active mode because they prefer to leave transmitter 121 or spare transmitter 121 in the vehicle or within the signal range of transmitter 121 and controller 103. The user can therefore selectively switch the described transmitter 121 from one state to the other by a switch resident in transmitter 121.

Disclosed herein is a system 101 that uses one or more passive transmitters 121. In this system it is foreseeable that one or more passive transmitters 121 will be within transmission range of controller 103 after the user leaves the vehicle with his/her transmitter 121. As an example, this scenario will occur when a spare or second remote transmitter 121 is left in the vehicle. Another example is when the vehicle is parked next to the user's home, with spare transmitters 121 in range of the vehicle. In these scenarios controller 103 will receive one or more passive disarm commands from one or more transmitters 121 and therefore compromise the security of the vehicle.

To overcome this shortcoming, the disclosed system comprises controller 103 that recognizes that one or more authorized transmitters 121 leaves the vehicle because its passive disarm signal is no longer received by controller 103. Once the passive signal of transmitter 121 is no longer received by controller 103, controller 103 arms even in the presence of other passive disarm signals received from one or more passive transmitters 121. Controller 103 continues to disregard such signals until the signal disappears and then reappears, suggesting that one of the transmitters 121 was taken out of the area and then returned, i.e. the holder of the transmitter 121 left and subsequently returned.

In an alternate embodiment, where passive and active (manual) command signals of transmitter 121 are distinguishable by one or more bits or characterizations of such command signal, the user anticipates or knows that controller 103 will not passively arm because one or more transmitters 121 are in its reception range. In that scenario, the user could place controller 103 in a forced-arm mode via a user initiated signal. The forced-arm mode can be activated in a number of ways. One example of the user initiated signal is to turn the ignition on and off in a rapid succession, such as twice in three seconds (although of course the number and time are can be selected by the manufacturer or user). Virtually any input sensible by controller 103, such as inputs 105, 151, ignition input or sensor input(s), alone or in combination, may be employed for this purpose. Once in forced-arm mode, after several seconds of non-operation and typically some indication that the user left the vehicle, such as the opening and closing of the driver's door pin 151, controller 103 will passively arm, even in the presence of one or more passive transmitters 121. Controller 103 will then remain in this mode until it is actively disarmed by an authorized transmitter 121. Once disarmed, controller 103 could remain in its forced-arm mode until such mode is disabled by the user, or in an alternate embodiment controller 103 could revert back to the passive arm mode.

Yet in another embodiment one of ordinary skill could set up the controller 103 to revert back to the passive arm mode before it is disarmed. In this embodiment controller 103 will enter the passive arm mode, and out of forced-arm mode after all passive transmitters are no longer detected by it.

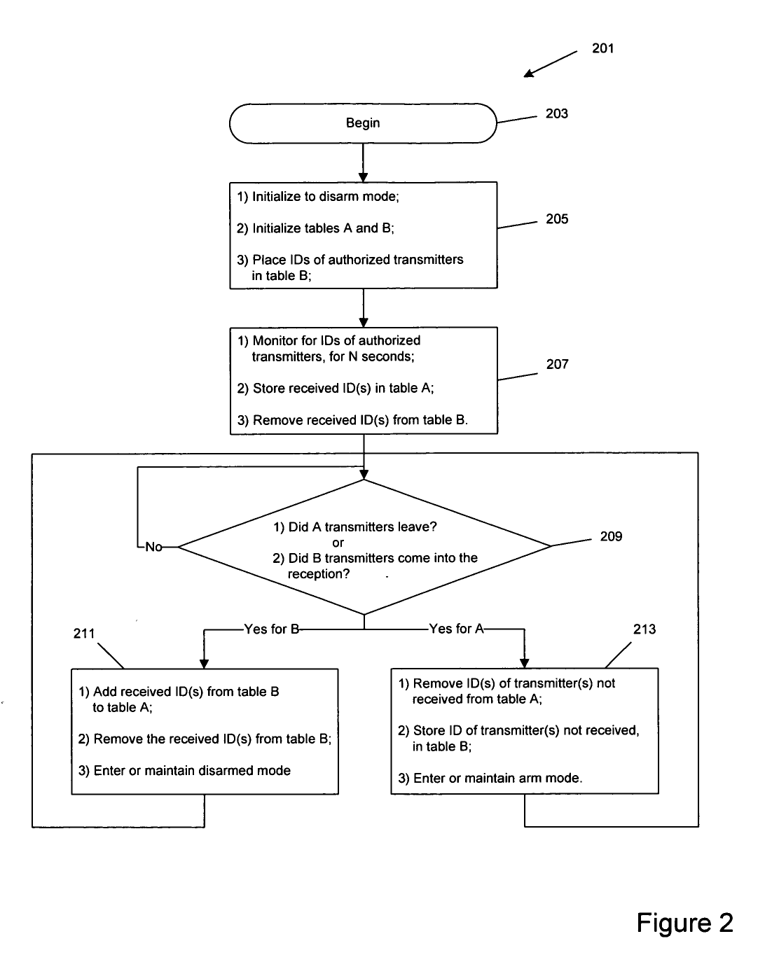

Such various embodiments and combinations thereof could be tailored in combination with other features, capabilities and demands of the system. FIG. 2 is a flowchart of one embodiment of forced-arm mode. In this embodiment 201, controller 103 begins the routine at 203. At 205, controller 103 initializes to a disarm mode, initializes tables A and B, and places authorized ID codes in table B. At 207, for some number of seconds, such as 15 seconds as an example, controller 103 monitors for one or more signals with an authorized ID code. If received, it places the authorized IDs in table A and removes such IDs from table B. This tracks the transmitters 121 that are in and out of the transmission range of the vehicle. Overall, blocks 205 and 207 set a starting point.

Then at 209 controller 103 continues to monitor for any changes. If no changes are detected, controller 103 will loop and continue the monitoring process. However, when one or more transmitters 121 leave the reception range of controller 103, the routine will proceed to 213. At 213 the ID(s) of transmitters 121 will be moved from table A to table B, controller 103 will arm or remain armed and return to block 209 for further monitoring.

Similarly, if one or more authorized transmitters 121 with ID(s) from table B are detected at 209, this is an indication that one or more authorized transmitters 121 came into the vicinity of the vehicle. Accordingly, the condition “Did B transmitters come into the reception?” will be satisfied at 209 and controller 103 will proceed to block 211. At 211 the received ID(s) will be moved from table B to table A, and consistent with the passive disarm mode, controller 103 will disarm or maintain its disarmed mode and loop back to 209. At 209 it will maintain its then current mode, until one of the transmitters 121, with its ID registered in table A is moved away from controller 103, sending the routine to block 213 as described above.

One of ordinary skill in the art will recognize that although FIG. 2 illustrates an exemplary embodiment, other functions and features could tailor the application. For example, the user could actively disarm controller 103 either via transmitter 121 or by a sequence of controls sensed by controller through one or more of its sensors or inputs, such as 143, 151 or 105. Yet in an alternate embodiment the user can operate in the typical passive arm mode and activate the forced-arm mode as describe above, by sending a signal to controller 103 via one or more signals from transmitter 121 or inputs 143, 151 or 105. Once in the forced-arm mode, controller 103 will arm and it will not respond to the passive disarm signals from authorized transmitters 121 until either such passive disarm signals are no longer received for a period of time, i.e. removed from reception range. In another embodiment controller 103 may be disarmed with an active disarm signal initiated by the user through one of the authorized transmitters 121. Once either of these conditions arises, controller 103 may be configured to revert to its passive-arm mode. In other embodiments, controller 103 may be programmed to remain in the forced-arm mode.

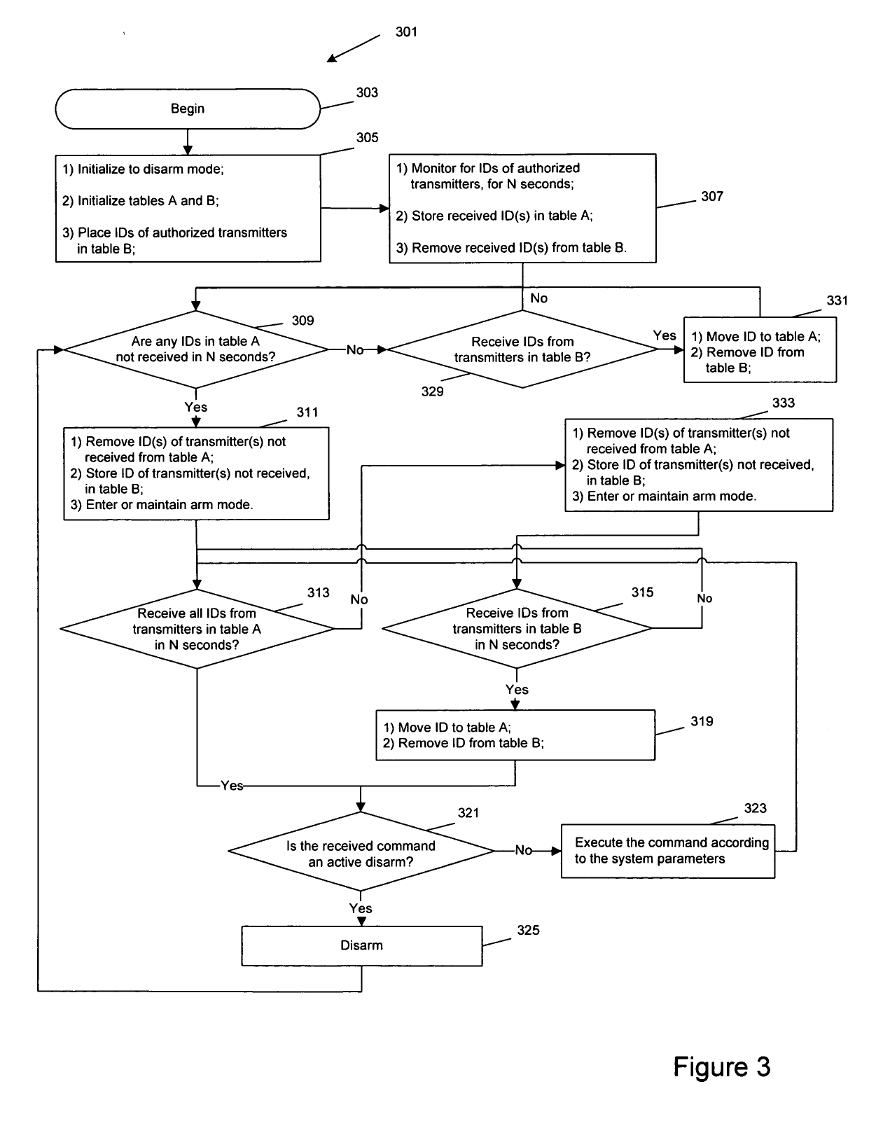

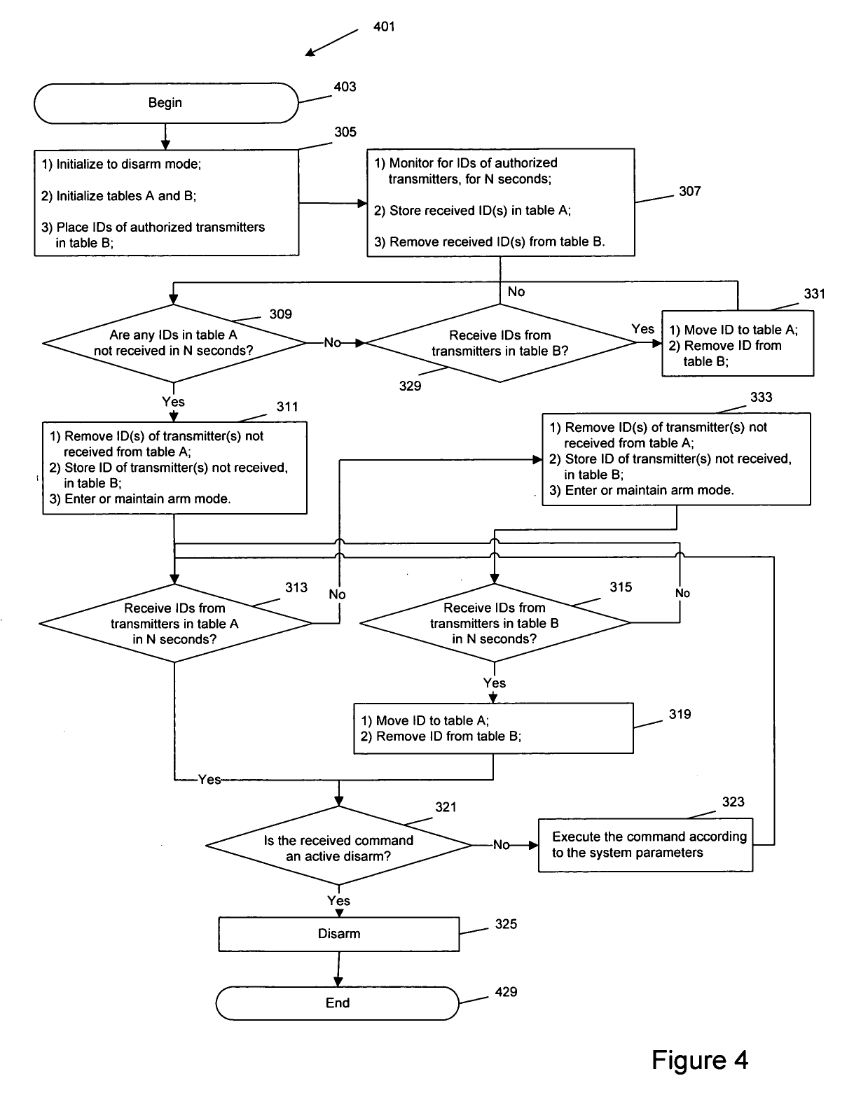

FIG. 3 illustrates a flowchart 301 that follows an alternate exemplary embodiment, wherein the user initiates the forced-arm mode. The forced-arm mode in this embodiment could be initiated by the user by sending controller 103 a signal. This signal could be any one or a combination of inputs sensible by controller 103, including without limitation, signals generated through activations of one or more inputs 105, switches 143, pin switches 151, sensors 147, and/or signals from transmitters 121. As will be explained in more detailed below, the forced-arm mode described for this embodiment could be configured as a settable mode by the user. In FIG. 3 the controller is configured to stay in this mode until stopped. In FIG. 4, it is configured as a one time routine, terminating upon receipt of an active disarm signal.

Turning now to the embodiment described in FIG. 3, controller 103 is configured to disarm upon receipt of an active disarm command from one or more transmitters 121. The process begins at 303. From 305 through 307 controller 103 senses what IDs and therefore the associated authorized transmitters 121 are in range of controller 103 and therefore at or near the vehicle. It places the ones in range in table A and the remainder remains in table B. Then at 309 controller 103 monitors IDs in table A for some period of time, such as 15 seconds as an example, although one could set the range to any desirable parameter. At 309, the absence of one or more IDs previously stored in table A indicates that one of the transmitters 121 was in range and is now out of range, i.e. an indication that the user and his/her remote moved away from the vehicle. Therefore, at 311 the IDs of those that were part of table A, but are now not received, are moved from table A to table B and controller 103 enters or maintains the armed mode. However, if all of the IDs registered in table A were received at 309, then controller proceeds to 329 to check if any new authorized transmitters 121 from table B were received in this period of time. If so, at 331 controller 103 registers the ID of such transmitters 121 to table A, i.e. ones in the vicinity of the vehicle, and removes the same ID from table B. Then controller 103 loops back to 309.

If however, at 309 not all of the IDs registered in table A are received within a designated time period, controller 103 proceeds to 313. In a similar fashion controller 103 now monitors for IDs from table A in a period of time. If all IDs are not received, it is indicative of one or more transmitters 121 moving out of transmission range from controller 103. In this case, at 333 controller moves the IDs that it did not receive from table A to table B and enters or maintains the armed mode. From 333 controller 103 proceeds to 315, where controller 103 checks if transmitters from table B were received. If not, controller 103 loops back to 313. If transmitter 121 was detected, at 319 its ID is registered in table A and removed from table B.

Both blocks 313 and 319 converge to block 321, where controller 103, having received a signal from one or more transmitters 121, decides if the command portion of the signal is an active disarm. If it is not, controller 103 proceeds to 323, where it executes the command it received from one or more authorized transmitters 121. Then, from 323 controller 103 loops back to 313 and continues to monitor the signals. However, if the received command is an active disarm, controller 103 disarms at 325. From 325 controller loops back to 309.

In another alternate embodiment, illustrated in FIG. 4, the forced-arm mode of FIG. 3 is a one-time process. In other words, as a general rule the user does not want controller 103 to passively arm in the presence of one or more passive transmitters 121. In this embodiment at 403 the user desires to activate the forced-arm mode as described above, employing one or more inputs sensible by controller 103, including without limitation, through activations of one or more inputs 105, switches 143, pin switches 151, sensors 147, and/or signals from transmitters 121. This embodiment largely follows the embodiment described in FIG. 3, but when controller 103 is disarmed as described above, after disarming at 325, it ends the routine at 429. Thus, if the user wants to initiate such forced-arm mode again, he would do so at 403.

Similarly, in another alternate embodiment, the forced-arm mode of FIG. 2 could be configured to a one-time process. To achieve that, one would terminate the loop of 211 to 209 and end after 211. Thereafter the user could activate the forced-arm mode as described above, employing one or more inputs sensible by controller 103, including without limitation, through activations of one or more inputs 105, switches 143, pin switches 151, sensors 147, and/or signals from transmitters 121.

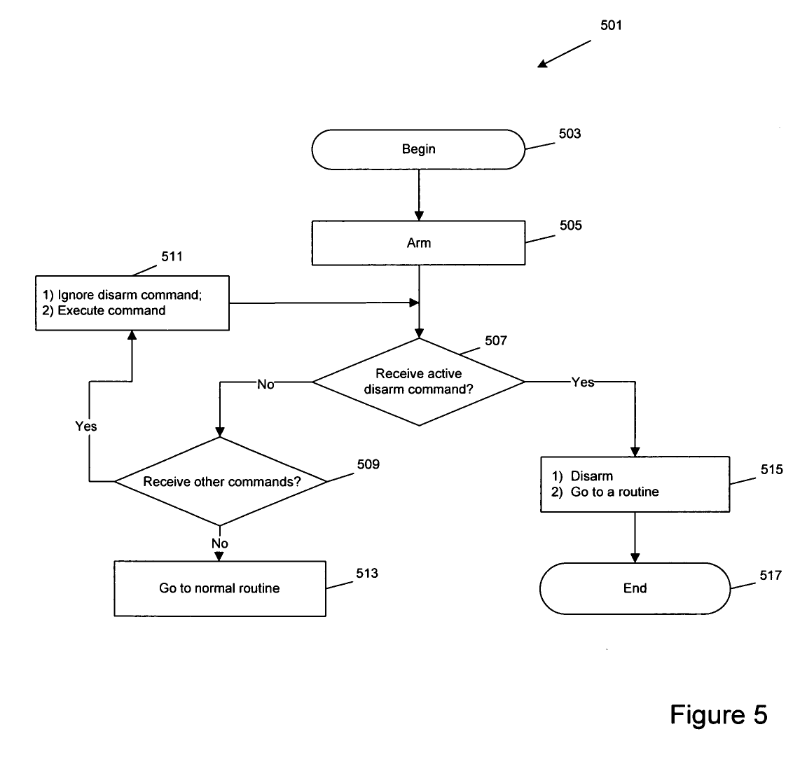

FIG. 5 illustrates an alternate embodiment where the user initiates the forced-arm mode. As described above, this could be achieved by sending controller 103 a user initiated signal or through another routine. In this embodiment controller 103 disregards passive disarm signals of transmitters 121 that were in place at the time of controller 103 initiated the routine.

Therefore, while such passive disarm signals are present, controller 103 disarms with an active disarm signal from one or more transmitters 121. However, if the passive transmitters are removed from the vicinity of controller 103, while it is in this forced-arm mode, it automatically changes to its nominal mode, such as the passive arm mode, as an example, where controller 103 disarms upon receipt of a passive disarm mode.

Turning now to FIG. 5, the routine begins at 501. Controller 103 arms at 505 either passively and in presence of passive disarm signals from one or more transmitters 121, or via active arm signal from the user's transmitter 121. At 507 controller is monitoring signals from authorized transmitters 121. To disarm in the presence of one or more authorized passive transmitters 121, controller has to receive an active disarm command/signal at 507. If it receives an active disarm signal, at 515 the controller disarms and changes to a normal routine, defined by the user or the manufacturer. Then the routine ends at 517. Note that FIG. 5 illustrates a one-time execution of the described forced-arm embodiment. However, one of skill in the art could tailor the disclosed embodiment to branch to another routine or loop back to the beginning. Thus, one of ordinary skill in the art could easily define the number of times controller 103 will repeat this sequence upon receipt of the user initiated signal or the start of this routine, ranging from once to a continuous loop with conditional disengaments, depending on the application.

At 507, if controller 103 does not receive an active disarm command, it monitors other commands at 509. If it receives such commands, at 511 it executes it, according to the parameters defined configured in controller 103. However, in this embodiment controller 103 ignores passive disarm commands. The routine then loops back to 507. This embodiment is configured to monitor for the presence of passive transmitters 121 and foresee that they may be removed from the vicinity of controller 103. If so, then if at 509 controller 103 does not receive any commands/signals from transmitters 121 for a period of time, such as 15 seconds as an example (could be any time parameter), it will assume that there are no passive transmitters 121 in its vicinity and controller 103 will proceed to 513, switching from the forced-arm mode embodiment of FIG. 5 to another mode. As an example, if controller 103 is configured to switch to the normal passive-arm mode, it would recognize the passive disarm commands of other authorized transmitters 121, when they return to the reception range of controller 103.

Yet in other embodiments controller 103 could call out or intermingle the disclosed embodiments. For example, controller 103 could be configured to execute the routine of FIG. 2 after the forced arm mode of FIG. 3 or FIG. 4. In this example, the user could initiate the forced arm mode again as described above or controller 103 could be configured to execute the embodiments shown and described in a manner tailored to suit a manufacturer's application.

Optionally some type of feedback indication could be provided to the user, indicating which of the disarm modes the system is in. Such indications could be visual or audible. Similarly, it is contemplated that the most versatile implementation of logic circuitry 131 is to employ a microprocessor. However, this is a discretionary choice that is not intended to limit the scope of the present invention. In the same tone, a fair reading of the disclosed embodiments provides much latitude in the process steps of the provided flowcharts. The embodiments may be tailored, combined or parceled. The embodiments could also be further supplemented without deviating from the teachings of this specification. For example, controller 103 could be configured to nominally operate in the forced-arm mode instead of the passive-arm mode, either by default or by signal/setting from the user as described above, such as in block 311.

While the present invention has been described herein with reference to particular embodiments thereof, a degree of latitude or modification, various changes and substitutions are intended in the foregoing disclosure. It will be appreciated that in some instances some features of the invention will be employed without corresponding use of other features without departing from the spirit and scope of the invention as set forth.

We claim:

1. A controller configured for installation in a vehicle and to respond to a plurality of transmitters having respective identification codes, wherein the controller is configured to respond to at least one command issued from at least one of the transmitters whose said identification codes are programmed into the controller, the controller comprising:
a) a disarmed mode and an armed mode, where in the armed mode the controller is configured to inhibit access to or operation of the vehicle;
b) at least one of the transmitters further comprising a passive mode, where in the passive mode the at least one transmitter is configured to passively transmit a disarm command; and
c) the controller configured to enter into the armed mode in the presence of the disarm command from the at least one transmitter operating in the passive mode.

2. The device of claim 1 wherein the controller is further configured to enter into the disarmed mode upon receipt of an active disarm command from the at least one of the transmitters.

3. The device of claim 1 wherein the disarm command from the at least one transmitter operating in the passive mode is a passive disarm command.

4. The device of claim 1 wherein the at least one transmitter is configured to transmit passive disarm commands in the passive disarm mode and a user activatable active disarm command.

5. The device of claim 1 further comprising at least one sensor coupled to the controller.

6. A controller configured for installation in a vehicle and to respond to a plurality of transmitters having respective identification codes, wherein the controller is configured to respond to at least one command issued from at least one of the transmitters whose said identification codes are programmed into the controller, the controller comprising:
a) a disarmed mode and an armed mode, where in the armed mode the controller is configured to inhibit access to or operation of the vehicle;
b) at least one of the transmitters further comprising a passive mode, where in the passive mode the at least one transmitter is configured to passively transmit a passive disarm command;
c) the controller configured to remain in the armed mode in the presence of the passive disarm command from the at least one transmitter operating in the passive mode; and
d) the controller configured to enter into the disarmed mode upon receipt of an active disarm command from the at least one of one of the transmitters.

7. The device of claim 6 wherein the at least one transmitter is configured to transmit passive disarm commands in the passive disarm mode and a user activatable active disarm command.

8. The device of claim 6 further comprising at least one sensor coupled to the controller.

9. The device of claim 6 further comprising a memory accessible by the controller, the controller registering the identification codes of the at least one transmitter operating in the passive mode in the memory.

10. A controller configured for installation in a vehicle and to respond to a plurality of transmitters having respective identification codes, wherein the controller is configured to respond to at least one command issued from at least one of the plurality transmitters whose said identification codes are programmed into the controller, the controller comprising:
a) a disarmed mode and an armed mode, where in the armed mode the controller is configured to inhibit access to or operation of the vehicle;
b) at least one of the transmitters further comprising a passive mode, where in the passive mode the at least one transmitter is configured to passively transmit a passive disarm command;
c) the controller configured to enter into remain in the armed mode upon receipt of at least one user initiated signal and in the presence of at least one of the passive disarm commands from the at least one transmitter operating in the passive mode; and
d) the controller configured to enter into the disarmed mode upon receipt of an active disarm command from the at least one of one of the transmitters.

11. The device of claim 10 wherein the at least one transmitter is configured to transmit passive disarm commands in the passive disarm mode and a user activatable active disarm command.

12. The device of claim 10 further comprising at least one sensor coupled to the controller.

13. The device of claim 10 further comprising a memory accessible by the controller, the controller registering the identification codes of the at least one transmitter operating in the passive mode in the memory.

14. The device of claim 10 wherein the user initiated signal comprises at least one signal initiated by the user through at least one sensor coupled to the controller.

15. The device of claim 10 wherein the user initiated signal comprises at least one activation of an ignition switch of the vehicle.

16. The device of claim 10 where the user initiated signal comprises at least one active signal initiated by the user through at least one user activatable switch of the at least one of the transmitters.

17. A controller configured for installation in a vehicle and to respond to a plurality of transmitters having respective identification codes, wherein the controller is configured to respond to at least one command issued from at least one of the transmitters whose said identification codes are programmed into the controller, the controller comprising:
a) a disarmed mode and an armed mode, where in the armed mode the controller is configured to inhibit access to or operation of the vehicle;
b) at least one of the transmitters further comprising a passive mode, where in the passive mode the at least one transmitter is configured to passively transmit a disarm signal comprising the identification code of the transmitter and a disarm command;
c) the controller configured to continuously register the identification codes of the at least one transmitter, within a reception range of the controller, operating in the passive disarm mode; and
d) the controller configured to operate in the armed mode in the absence of the disarm command from the at least one transmitter whose identification code was registered by the controller.

18. The device of claim 17 wherein the at least one transmitter is configured to transmit a user activatable active disarm command.

19. The device of claim 17 further comprising at least one sensor coupled to the controller.

20. A controller configured for installation in a vehicle and to respond to a plurality of transmitters having respective identification codes, wherein the controller is configured to respond to at least one command issued from at least one of the transmitters whose said identification codes are programmed into the controller, the controller comprising:
a) a disarmed mode and an armed mode, where in the armed mode the controller is configured to inhibit access to or operation of the vehicle;
b) at least one of the transmitters further comprising a passive mode, where in the passive mode the at least one transmitter is configured to passively transmit a disarm signal comprising the identification code of the transmitter and a disarm command;
c) the controller configured to continuously register the identification codes of the at least one transmitter, within a reception range of the controller, operating in the passive disarm mode;
d) the controller configured to operate in the armed mode in the absence of the disarm command from the at least one transmitter whose identification code was registered by the controller; and
e) the controller further configured to operate in the disarmed mode upon receipt of the disarm signal from the at least one transmitter, wherein said signal comprises the disarm command and the identification code that is not registered.

21. A controller configured for installation in a vehicle and to respond to a plurality of transmitters having respective identification codes, wherein the controller is configured to respond to at least one command issued from at least one of the plurality transmitters whose said identification codes are programmed into the controller, the controller comprising:
a) a disarmed mode and an armed mode, where in the armed mode the controller is configured to inhibit access to or operation of the vehicle;
b) at least one of the transmitters further comprising a passive mode, where in the passive mode the at least one transmitter is configured to passively transmit a passive disarm signal comprising an identification code and a passive disarm command;
c) the controller configured to enter into remain in the armed mode upon receipt of at least one user initiated signal and in the presence of at least one of the passive disarm signals from the at least one transmitter operating in the passive mode; and
d) the controller configured to enter into the disarmed mode either upon receipt of an active disarm command from the at least one of one of the transmitters or receipt of the passive disarm signal from the at least one of the transmitters, after the controller stopped receiving the passive disarm signals from the transmitters for a period of time at least exceeding a period of time between consecutive passive disarm signals of the transmitters.
